(19) United States
(12) Patent Application Publication
(10) Pub. No.: US 2013/0253696 A1
(43) Pub. Date: Sep. 26, 2013

(54) Thermal Management of Molding System

(71) Applicant: Brian Esser, Colchester, VT (US)

(72) Inventor: Brian Esser, Colchester, VT (US)

(73) Assignee: HUSKY INJECTION MOLDING SYSTEMS LTD., Bolton, ON (CA)

(21) Appl. No.: 13/991,440

(22) PCT Filed: Nov. 16, 2011
(86) PCT No.: PCT/US11/60953

§ 371 Date: Jun. 4, 2013

Related U.S. Application Data
(60) Provisional application No. 61/422,671, filed on Dec. 14, 2010.

(51) Int. Cl. G01K 1/02

(52) U.S. Cl. CPC G01K 1/026
USPC 700/205

(57) ABSTRACT

A system (100), including: a computer-usable medium (102) embodying a set of instructions (106) being executable by a computer (120), the computer (120) being configured to be connected with and to control a grouping of thermal-management assemblies (142) being associated with respective thermal-management of a molding system (140), the set of instructions (106) including computer-executable instructions for directing the computer (120) to perform, in use, a collection of operations, the collection of operations including: a thermal-management operation (S101), including: management of application of power to the grouping of thermal-management assemblies (142) of the molding system (140).

### TECHNICAL FIELD

An aspect generally relates to (but is not limited to) a system including operation for thermal management of a molding system.

### BACKGROUND

United States Patent Publication Number 2006/0196957 discloses a method and apparatus for controlling the temperature of molds, dies, and injection barrels using fluid media. In another circulator embodiment the controller gets a signal from the molding machine that indicates a “cycle-start”, the moment when each new cycle commences. This information may be used alone or in combination with other process data for temperature control. Other embodiments may use real time data on any or all of various system variables including temperature, pressure, flow rate, valve position, cycle-start, cycle-end, and various fault signals, in the dynamic control of the loop fluid temperature and/or the mold process temperature. The quantity and delivery profile may be pre-calculated for startup, and be further adjusted in real time using appropriate sensors in either line of the control loop or on the machine itself.

United States Patent Publication Number 2007/0057394 discloses an apparatus and method for temperature control. For example, during start-up it is desirable to add heat as rapidly as possible to bring hot runner system to an operating temperature. During idle, less heat may be required from heaters to maintain a desired temperature, particularly in systems that include equipment for rapidly removing heat from mold assembly that are inactive in idle mode. Hence, different algorithms may be employed for control under “start-up”, “steady-state”, and “idle” operation of any of heaters. In addition, different algorithms are employed to effect temperature responsive control using a temperature set point and sensed temperature and proportional control responsive to a proportioning set point. In accordance with the nature of the control algorithm used, set point values may be defined for: (i) temperatures for cold start up, normal, and idle operation; (ii) limits of electrical current delivered to the connected heater; (iii) control algorithm parameters such as gain (proportional constant), integral constants and differential constants; (iv) load resistance; (v) load power; (vi) thermal response lag time; and, (vii) average power to maintain temperature set point. Set point values are associated with each zone, each zone having a unique identifier such as a zone number. Set point data are advantageously stored to permit retrieval using an index defined by an appropriate zone identifier.

United States Patent Publication Number 2002/0143426 discloses an inertial temperature control system and method. The ideas involved in inertial temperature control have to do with how the temperature set point is managed. In known temperature control methods used in the semiconductor industry, an object or a body, such as a semiconductor wafer, is typically temperature ramped in a linear fashion. The actual temperature of the body cannot match the linear ramp rate, so it lags at the start, and overshoots at the end. In contrast, the present invention provides a temperature set point versus time curve that more closely matches the curve that a real object is capable of following. Thus, the present invention accounts for the “inertial” nature of temperature changes, and controls the set point to allow the actual temperature of a body to follow the set point more closely and thereby minimize overshoot while achieving temperature stability more rapidly than prior art straight linear ramp methods.

United States Patent Publication Number 2009/0267253 discloses a sub-controller that is provided for controlling the screw rotation during startup of the injection molding machine, and more particularly, prior to injection molding machine entering a plastic processing state where processed plastic is flowing through the injection molding machine appropriately for making parts.

### SUMMARY

The inventors have researched a problem associated with known molding systems that inadvertently manufacture bad-quality molded articles or parts. After much study, the inventors believe they have arrived at an understanding of the problem and its solution, which are stated below; the inventors believe this understanding may not be known to the public by way of available publications. Molds may be manually started by turning on various heating and cooling systems at various times during a startup sequence of a molding system. Various components (such as manifolds, barrels, sprues, etc.) may arrive at a processing temperature (also called a set-point temperature) at different times. As the molding system cannot start operating until all components are up to operating temperature, energy may be wasted to maintain various components at operating temperature while remaining components continue to heat up toward operating temperature. It may be very difficult to manually start each heater assembly (and possibly each cooling system) in such a way that all of the components arrive at the processing temperature simultaneously. Attempts at doing so may likely increase time that may be required to bring the molding system up to operating temperature.

According to one aspect, there is provided a system (100), comprising: a computer-usable medium (102) embodying a set of instructions (106) being executable by a computer (120), the computer (120) being configured to be connected with and to control a grouping of thermal-management assemblies (142) being associated with respective thermal-management of a molding system (140), the set of instructions (106) including computer-executable instructions for directing the computer (120) to perform, in use, a collection of operations, the collection of operations including: a thermal-management operation (S101), including: management of application of power to the grouping of thermal-management assemblies (142) of the molding system (140).

Other aspects and features of the non-limiting embodiments will now become apparent to those skilled in the art upon review of the following detailed description of the non-limiting embodiments with the accompanying drawings.

### DETAILED DESCRIPTION OF THE DRAWINGS

The non-limiting embodiments will be more fully appreciated by reference to the following detailed description of the non-limiting embodiments when taken in conjunction with the accompanying drawings, in which:

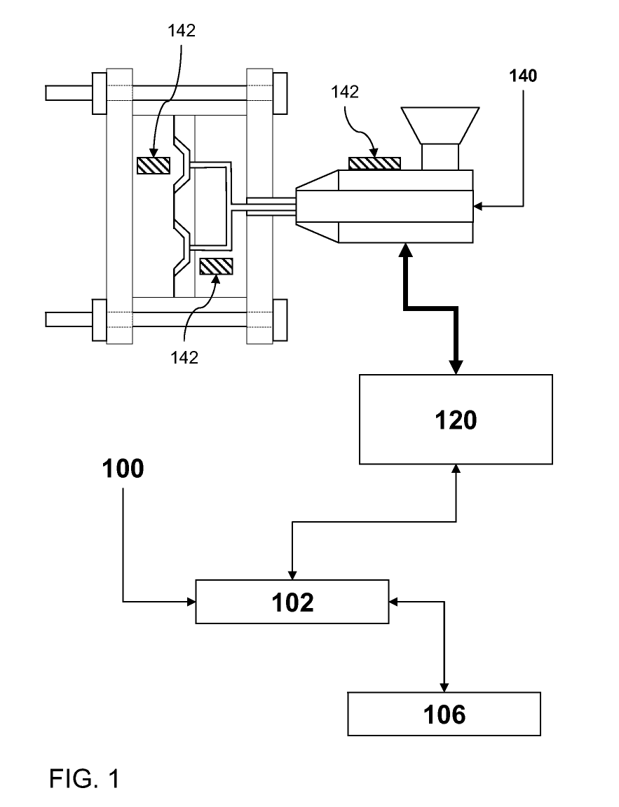

FIGS. 1, 2, 3, 4, 5, 6, 7 depict schematic representations associated with the non-limiting embodiment(s) of the system (100).

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF THE NON-LIMITING EMBODIMENT(S)

FIGS. 1, 2, 3, 4, 5, 6, 7 depict the schematic representations associated with the non-limiting embodiment(s) of the system (100). The system (100) may include components that are known to persons skilled in the art, and these known components will not be described here; these known components are described, at least in part, in the following reference books (for example): (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Systems” 3^{rd} Edition authored by JOHANNABER (ISBN 3-446-17733-7) and/or (iv) “Runner and Gating Design Handbook” authored by BEAUMONT (ISBN 1-446-22672-9). It will be appreciated that for the purposes of this document, the phrase “includes (but is not limited to)” is equivalent to the word “comprising”. The word “comprising” is a transitional phrase or word that links the preamble of a patent claim to the specific elements set forth in the claim which define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim.

FIG. 1 depicts a schematic representation of a computer (120) and of a molding system (140). The system (100) may include by way of example (and is not limited to): a computer-usable medium (102) embodying a set of instructions (106) that are executable by the computer (120). The computer-usable medium (102) may include (and is not limited to) for example: a floppy disc, a compact disc (CD), a flash memory device, random-access memory (RAM is a form of computer data and/or program storage), etc. The computer (120) may be a programmable machine that receives input, stores and manipulates data, and provides output in a useful format. While the computer (120) may be made out of almost anything (such as silicon), and mechanical examples of computers (such as babbage machines) have existed through much of recorded human history; the first electronic computers were developed in the mid-20th century. Modern computers based on integrated circuits are millions to billions of times more capable than the early computing machines (aka computers). Some computers may be small enough to fit into mobile devices (such as cell phone for example), and may be powered by a small battery. Embedded computers may be found in many devices, such as toasters. The set of instructions (106) may include instructions written using a programming language. The programming language may be an artificial language designed to express computations that may be performed by the computer (120). Programming languages may be used to create executable instructions or programs that control the behavior of the computer (120), to express algorithms (operations) precisely, or as a mode of human communication. Many programming languages have some form of written specification of their syntax (form) and semantics (meaning). Some languages are defined by a specification document. For example, the C programming language is specified by an ISO Standard. Other languages, such as Perl, have a dominant implementation used as a reference. The programming language may describe computation in an imperative style, i.e., as a sequence of commands, although some languages, such as those that support functional programming or logic programming, use alternative forms of description. The computer (120) may have one or more processors, which may be referred to as a Central processing unit (CPU) that is an electronic circuit that can execute computer programs.

The defining feature of modern computers which distinguishes them from all other machines is that they can be programmed. That is to say that some type of instructions (the program) can be given to the computer, and it will carry process them. While some is computers may have strange concepts “instructions” and “output” (see quantum computing), modern computers based on the von Neumann architecture are often have machine code in the form of an imperative programming language. In practical terms, a computer program may be just a few instructions or extend to many millions of instructions, as do the programs for word processors and web browsers for example. A computer may execute billions of instructions per second (gigaflops) and rarely makes a mistake over many years of operation. Large computer programs consisting of several million instructions may take teams of programmers may years to write, and due to the complexity of the task almost certainly may contain errors.

In most computers, individual instructions are stored as machine code with each instruction being given a unique number (its operation code or opcode for short). The command to add two numbers together would have one opcode, the command to multiply them would have a different opcode and so on. The simplest computers are able to perform any of a handful of different instructions; the more complex computers have several hundred to choose from—each with a unique numerical code. Since the computers memory is able to store numbers, it can also store the instruction codes. This leads to the important fact that entire programs (which are just lists of these instructions) can be represented as lists of numbers and can themselves be manipulated inside the computer in the same way as numeric data. The fundamental concept of storing programs in the computers memory alongside the data they operate on is the crux of the von Neumann, or stored program, architecture. In some cases, a computer might store some or all of its program in memory that is kept separate from the data it operates on. This is called the Harvard architecture after the Harvard Mark I computer. Modern von Neumann computers display some traits of the Harvard architecture in their designs, such as in CPU caches.

While it is possible to write computer programs as long lists of numbers (machine language) and while this technique was used with many early computers, it is extremely tedious and potentially error-prone to do so in practice, especially for complicated programs. Instead, each basic instruction can be given a short name that is indicative of its function and easy to remember—a mnemonic such as ADD, SUB, MULT or JUMP. These mnemonics are collectively known as a computer's assembly language. Converting programs written in assembly language into something the computer can actually understand (machine language) is usually done by a computer program called an assembler. Machine languages and the assembly languages that represent them is (collectively termed low-level programming languages) tend to be unique to a particular type of computer.

Higher-level languages and program design: though considerably easier than in machine language, writing long programs in assembly language is often difficult and is also error prone. Therefore, most practical programs are written in more abstract high-level programming languages that are able to express the needs of the programmer more conveniently (and thereby help reduce programmer error). High level languages are usually “compiled” into machine language (or sometimes into assembly language and then into machine language) using another computer program called a compiler. High level languages are less related to the workings of the target computer than assembly language, and more related to the language and structure of the problem(s) to be solved by the final program. It is therefore often possible to use different compilers to translate the same high level language program into the machine language of many different types of computer. This is part of the means by which software like video games may be made available for different computer architectures such as personal computers and various video game consoles.

The task of developing large software systems presents a significant intellectual challenge. Producing software with an acceptably high reliability within a predictable schedule and budget has historically been difficult; the academic and professional discipline of software engineering concentrates specifically on this challenge.

Some computers are designed to distribute their work across several CPUs in a multiprocessing configuration, a technique once employed only in large and powerful machines such as supercomputers, mainframe computers and servers. Multiprocessor and multi-core (multiple CPUs on a single integrated circuit) personal and laptop computers are now widely available, and are being increasingly used in lower-end markets as a result. Supercomputers in particular often have highly unique architectures that differ significantly from the basic stored-program architecture and from general purpose computers. They often feature thousands of CPUs, customized high-speed interconnects, and specialized computing hardware. Such designs tend to be useful only for specialized tasks due to the large scale of program organization required to successfully utilize most of the available resources at once. Supercomputers usually see usage in large-scale simulation, graphics rendering, and cryptography applications, as well as with other so-called “embarrassingly parallel” tasks.

While a computer may be viewed as running one gigantic program stored in its main memory, in some systems it is necessary to give the appearance of running several programs simultaneously. This is achieved by multitasking i.e. having the computer switch rapidly between running each program in turn. One means by which this is done is with a special signal called an interrupt which can periodically cause the computer to stop executing instructions where it was and do something else instead. By remembering where it was executing prior to the interrupt, the computer can return to that task later. If several programs are running “at the same time”, then the interrupt generator might be causing several hundred interrupts per second, causing a program switch each time. Since modern computers typically execute instructions several orders of magnitude faster than human perception, it may appear that many programs are running at the same time even though only one is ever executing in any given instant. This method of multitasking is sometimes termed “time-sharing” since each program is allocated a “slice” of time in turn. Before the era of cheap computers, the principle use for multitasking was to allow many people to share the same computer. Seemingly, multitasking would cause a computer that is switching between several programs to run more slowly—in direct proportion to the number of programs it is running. However, most programs spend much of their time waiting for slow input/output devices to complete their tasks. If a program is waiting for the user to click on the mouse or press a key on the keyboard, then it will not take a “time slice” until the event it is waiting for has occurred. This frees up time for other programs to execute so that many programs may be run at the same time without unacceptable speed loss.

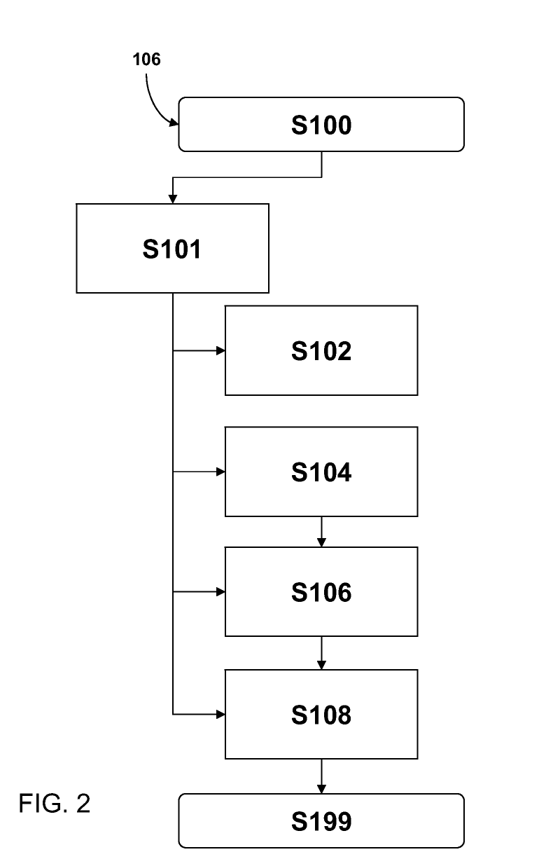

The computer (120) may be configured to be connected with and to control a grouping of thermal-management assemblies (142), such as heater assemblies and/or cooling assemblies, which are associated with respective thermal-management zones (heating zones, cooling zones, etc) of the molding system (140). The set of instructions (106) may include by way of example (and is not limited to): computer-executable instructions for directing the computer (120) to perform, in use, a collection of operations. The collection of operations may include by way of example (and is not limited to) the schematic representations depicted in FIGS. 2, 3, 4, 5.

FIG. 2 depicts a schematic representation of an example of the collection of operations that may be performed by the computer (120) of FIG. 1 by configuring the set of instructions (106) accordingly. The collection of operations may include by way of example (and is not limited to): a thermal-management operation (S101). The thermal-management operation (S101) may include by way of example (and is not limited to): management of application of power to the grouping of thermal-management assemblies (142) of the molding system (140), on a general basis.

The thermal-management operation (S101) may further include by way of example (and is not limited to): a determination operation (S102). The determination operation (S102) may include by way of example (and is not limited to): a determination operation (S102), including: determining thermal characterization of the molding system (140).

The thermal-management operation (S101) may further include by way of example (and is not limited to): a determining operation (S104). The determining operation (S104) may include by way of example (and is not limited to): determining a process for application of operational power to the grouping of thermal-management assemblies (142) during a start-up operation of the molding system (140), for improved (preferably maximum) efficiency of operation of the molding system (140).

The thermal-management operation (S101) may further include by way of example (and is not limited to): an identification operation (S106). The identification operation (S106) may include by way of example (and is not limited to): identifying a procedure for application of paused power to the grouping of thermal-management assemblies (142) during a pause in the manufacturing operation of the molding system (140).

The thermal-management operation (S101) may further include by way of example (and is not limited to): a combination of the determination operation (S102), the determining operation (S104), and the identification operation (S106).

The system (100) may include (and is not limited to): learning algorithms to determine any one or more of the following in any combination and or permutation: (a) when to start each thermal-management zone during a startup sequence of the molding system (140), (b) how to power the thermal-management zone for improved (preferably maximum) efficiency, (c) is perform a startup sequence based on the specific system parameters to start the system in accordance with a reduced (preferably minimum) amount of time and with the reduced (preferably minimum) amount of energy consumption, and/or (d) control of a thermal-management process may be integrated into the system (100) if so desired.

According to an option, the thermal-management operation (S101) may further includes (and is not limited to): a management operation, including managing application of power to the grouping of thermal-management assemblies (142) of the molding system (140) in accordance to any one of: (i) a way that minimizes energy consumption, and/or (ii) a way that minimizes heat up time.

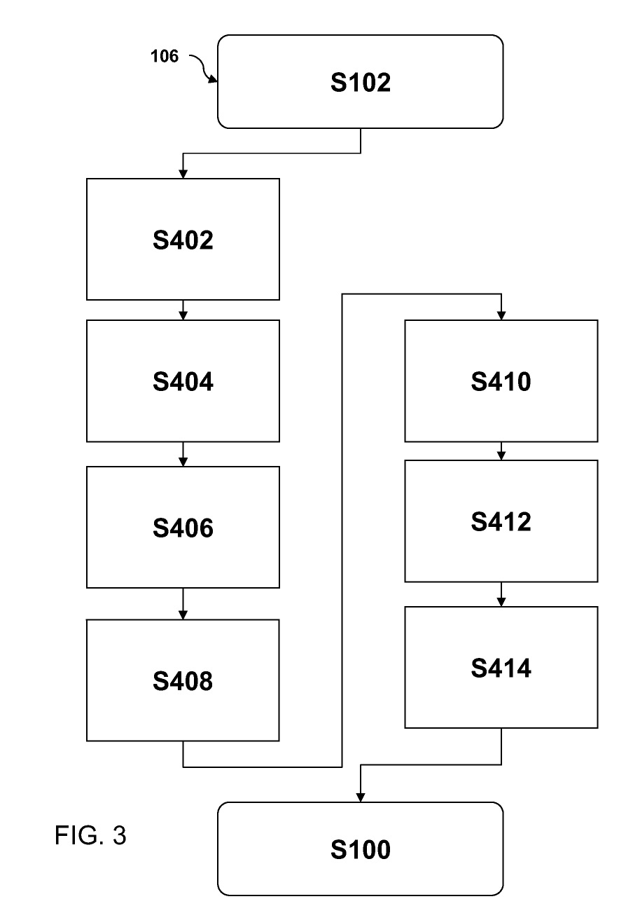

FIG. 3 depicts another schematic representation of another example of the collection of operations that may be performed by the computer (120) of FIG. 1. The operations depicted in FIG. 3 may be used to characterize the molding system (140). The determination operation (S102) may further by way of example (and is not limited to): (i) an application operation (S402), (ii) a monitoring operation (S404), (iii) a power-off operation (S406), (iv) a watching operation (S408), (v) a creating operation (S410), (vi) a repeating operation (S412), and/or (vii) a generating operation (S414). The application operation (S402) may include by way of example (and is not limited to): applying power to a thermal-management assembly (142) (such as a heater assembly or a cooling system) of the molding system (140). The monitoring operation (S404) may include by way of example (and is not limited to): monitoring temperature response on a temperature sensor (such as a thermocouple) connected to the thermal-management assembly (142). The power-off operation (S406) may include by way of example (and is not limited to): turning off power to the thermal-management assembly (142). The watching operation (S408) may include by way of example (and is not limited to): monitoring temperature response on temperature sensor (such as a thermocouple) connected to the thermal-management assembly (142). The creating operation (S410) may include by way of example (and is not limited to): creating a thermal-management influence vector (that is, a heat-up and/or a cool-down influence vector) for the thermal-management assembly (142) for all temperature sensors associated with the thermal-management assembly (142), which may include time and/or magnitude characteristics. The repeating operation (S412) may include by way of example (and is not limited to): repeat the operations (S402), (S404), (S406), (S408), (S410) for all remaining thermal-management zones of the molding system (140). The generating operation (S414) may include by way of example (and is not limited to): generating a is master-influence matrix for each thermal-management device on each thermal-management zone.

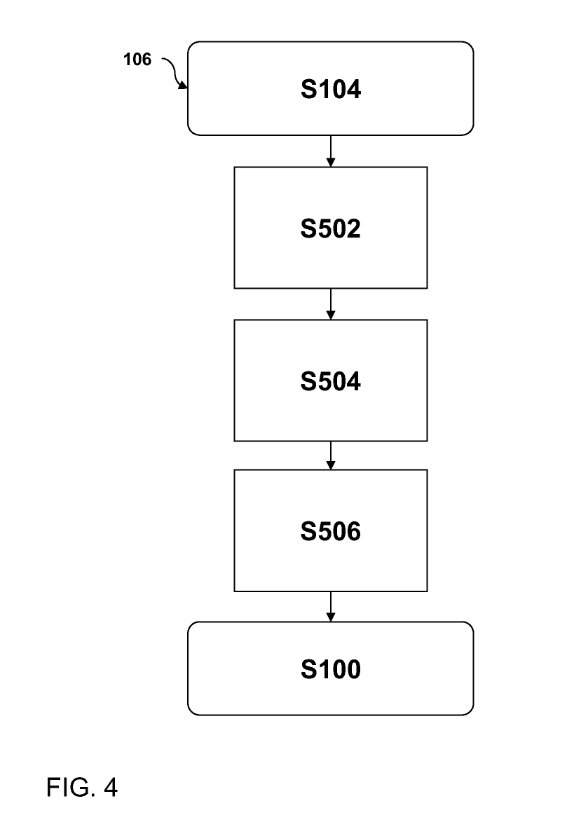

FIG. 4 depicts yet another schematic representation of another example of the collection of operations that may be performed by the computer (120) of FIG. 1. The operations depicted in FIG. 4 may be used to characterize the molding system (140) to determine the manner in which the molding system (140) may startup (that is, a start up sequence). The determining operation (S104) may further include by way of example (and is not limited to): (i) an input operation (S502), (ii) a using operation (S504), and (iii) an application operation (S506). The input operation (S502) may include by way of example (and is not limited to): receiving user inputs for desired thermal set-points for the molding system (140). The using operation (S504) may include by way of example (and is not limited to): using the master-influence matrix, and then determine a power-up sequence for each thermal-management zone, knowing how each thermal-management device's applied power affects the thermal-management zones of the molding system (140). The application operation (S506) may include by way of example (and is not limited to): applying power based on calculations performed above, and bring the molding system (140) up to an operational temperature, preferably in shortest possible time with lowest possible power if possible.

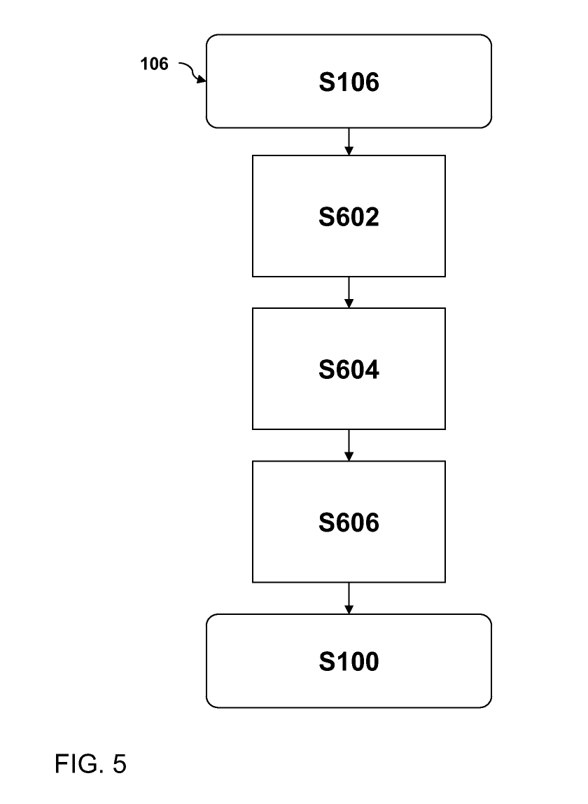

FIG. 5 depicts yet another schematic representation of another example of the collection of operations that may be performed by the computer (120) of FIG. 1. The operations depicted in FIG. 5 may be used to manage the thermal requirements of the molding system (140) during a pause in the manufacturing operation of the molding system (140). The identification operation (S106) may further include by way of example (and is not limited to): (i) an inputting operation (S602), (ii) a using operation (S604), and (iii) a waiting operation (S606). The inputting operation (S602) may include by way of example (and is not limited to): inputting or receiving user inputs identifying a desired pause time or a desired restart time. The using operation (S604) may include by way of example (and is not limited to): using the master-influence matrix so as to determines off time for each thermal management zone and turn the thermal-management devices back on to bring the molding system (140) back up to operating temperature, while preferably consuming the minimum power during the system pause. The waiting operation (S606) may include by way of example (and is not limited to): waiting for the molding system (140) to go back up to operating temperature after a prescribed pause duration.

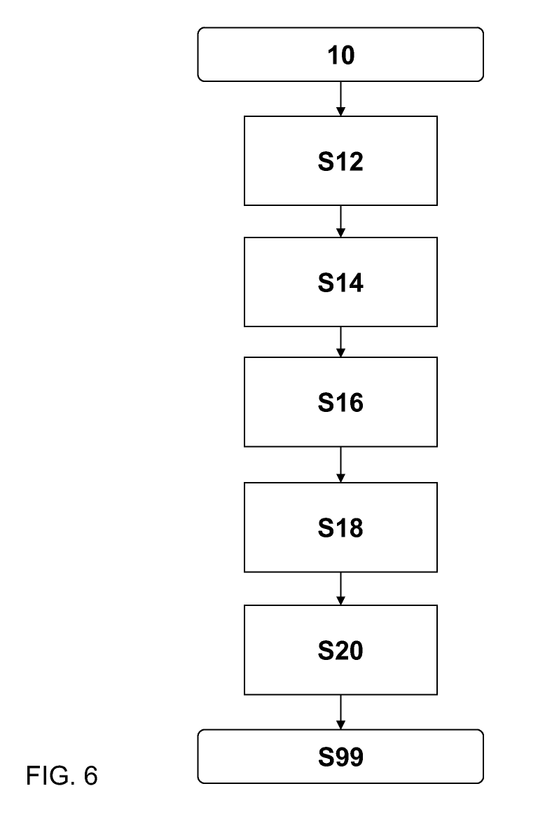

FIG. 6 depicts an example of operational sequence 10 in which the molding system (140) may undergo as a result of using the system (100). Operation (S12) includes heating up the barrel assembly of the molding system (140) to an operating temperature of the barrel assembly. Operation (S14) includes heating up the manifold assembly of the molding system (140) to an operating temperature of the manifold assembly. Operation (S16) includes heating up a nozzle tip of the molding system (140) to an operating temperature of the nozzle tip. Operation (S18) including heating up a sprue assembly an operating temperature of the sprue assembly of the molding system (140). Operation (S20) including having the molding system (140) manufacture molded parts. Operation (S99) may include stopping operation of the molding system (140) for any suitable given reason as may be required.

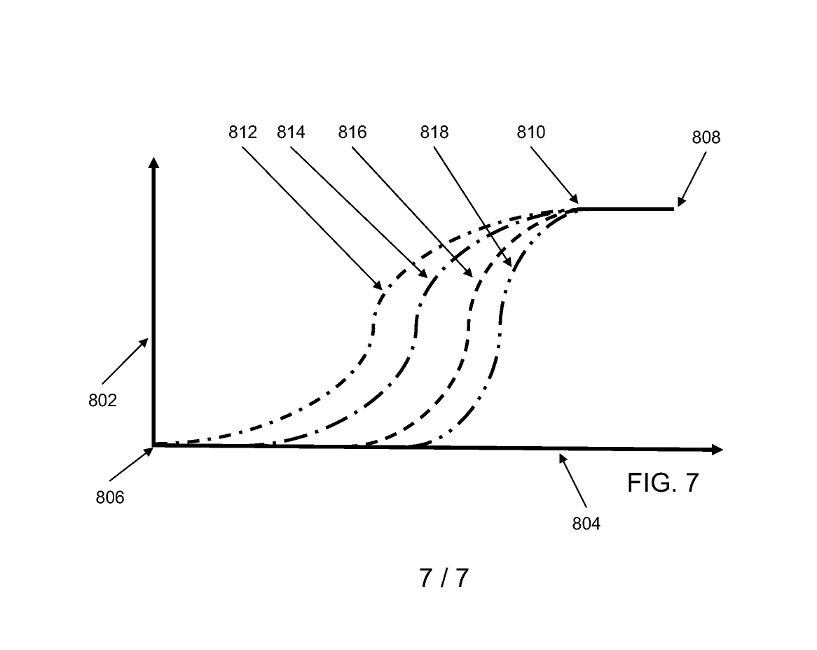

FIG. 7 depicts a temperature graph associated with an example operation of the molding system (140) of FIG. 1 that may be achieved with the use of the system (100) of FIG. 1. A temperature axis (802) indicates a temperature range of the components of the molding system (140). A time axis (804) indicates the passage of time. A machine start time (806) indicates when the molding system (140) undergoes a start up sequence. An operating temperature (808) indicates the operating temperature of the molding system (140). An earliest possible start time (810) for making parts is indicated as well, once all the components of the molding system (140) have reached their respective operating temperatures. A barrel temperature curve (812) indicates that the barrel assembly is initially begun heating up. A manifold temperature curve (814) indicates that the manifold assembly is heated up after the barrel assembly has begun its heat up cycle. A nozzle tip temperature curve (816) indicates that a nozzle tip is heated up after the manifold assembly has begun its heat up cycle. A sprue temperature curve (818) indicates that a sprue assembly is heated up after the nozzle tip has begun its heat up cycle.

In summary, operation (S101) may resolve the problem by using learning algorithms to determine time constants of various thermal-management assemblies and cooling assemblies in relation to each other and providing an automated startup sequence that allows all thermal management zones of the molding system (140), such as thermal-management assemblies, cooling assemblies, etc, to be turned on, off and/or controlled in such a way that the thermal-management assemblies arrive at their proper operating temperature set-points simultaneously or nearly simultaneously (or not), thereby reducing energy required or consumed for the startup sequence of the molding system (140). By is learning how each thermal management assembly responds to control parameters, and creating an optimized startup control strategy for each thermal-control zone, the molding system (140) may be started with an initiation command and ensure that less energy is wasted maintaining some thermal-control zones at their set-point temperatures while other thermal-management zones coming up to their operating temperature. The system (100) may ease the effort associated with startup, and/or may also do so in a (relatively) faster and (relatively) more energy efficient manner. In addition to the energy savings, the system (100) may also provide for more advanced diagnostics. By comparing the response of the molding system (14) at each startup to the previously recorded time constant (time-temperature) parameters, issues with the molding system (140) may be identified before a problem becomes more serious. Examples of this may include and is not limited to: (i) lack of mold cooling (incorrect water temperature, blocked flow, or no flow), (ii) thermocouple issues (loose or failed temperature sensors), (iii) resin contamination (slowing the rate of temperature rise by sinking heat during startup), etc. The system (100) may be also configured to check to ensure that the molding system (14) is performing correctly at a system level. Safety features may also be integrated into the startup sequence for the molding system (140), for example ensuring the sprue is at the proper temperature relative to the barrel and the manifold, ensuring that hot plastic does not erupt through the sprue due to the blowing of a cold slug. In addition, pause features may be implemented in the system (100) as well, where the user inputs a duration of a pause in processing and the computer (120) ensures that the molding system (140) is back fully up to operating temperature and ready to start processing (manufacturing molded parts) at the conclusion of the pause duration while also reducing energy consumed during the pause; that is, each thermal management zone may be allowed to cool as desired, and the system (100) would then begin repowering everything back up in proportion to their current temperatures. The system (100) may require a different sequence compared to a cold start (as each zone would cool at a different rate and thus start re-heating at different temperatures), and may again result in reducing the energy required to have the molding system (140) back online at the desired time, but may also ensure that the molding system (140) is ready to go at that time. It is envisioned that this functionality may be included in a hot runner controller, which is an example of the computer (120), and/or may be included in a machine controller (another example of the computer (120)) to control barrel temperatures, etc. Additionally, the system (100) may be integrated into a cooling-system controller to turn the cooling effect on at the most appropriate time during startup to further maximize the speed and efficiency of the startup sequence of the molding system (140).

It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (and is not limited to)” is equivalent to the word “comprising”. It is noted that the foregoing has outlined the non-limiting embodiments (examples). The description is made for particular non-limiting embodiments (examples). It is understood that the non-limiting embodiments are merely illustrative as examples.

What is claimed is:

1. A system (100), comprising:
a computer-usable medium (102) embodying a set of instructions (106) being executable by a computer (120), the computer (120) being configured to be connected with and to control a grouping of thermal-management assemblies (142) being associated with respective thermal-management zones of a molding system (140), the set of instructions (106) including computer-executable instructions for directing the computer (120) to perform, in use, a collection of operations, the collection of operations including:
a thermal-management operation (S101), including:
management of application of power to the grouping of thermal-management assemblies (142) of the molding system (140).

2. The system (100) of claim 1, wherein:
the thermal-management operation (S101) further includes:
a determination operation (S102), including:
determining thermal characterization of the molding system (140).

3. The system (100) of claim 1, wherein:
the thermal-management operation (S101) further includes:
a determining operation (S104), including:
determining a process for application of operational power to the grouping of thermal-management assemblies (142) during a start-up operation of the molding system (140).

4. The system (100) of claim 1, wherein:
the thermal-management operation (S101) further includes:
an identification operation (S106), including:
identifying a procedure for application of paused power to the grouping of thermal-management assemblies (142) during a pause in a manufacturing operation of the molding system (140).

5. The system (100) of claim 1, wherein:
the thermal-management operation (S101) further includes:
a determination operation (S102), including:
determining thermal characterization of the molding system (140);
a determining operation (S104), including:
determining a process for application of operational power to the grouping of thermal-management assemblies (142) during a start-up operation of the molding system (140); and
an identification operation (S106), including:
identifying a procedure for application of paused power to the grouping of thermal-management assemblies (142) during a pause in a manufacturing operation of the molding system (140).

6. The system (100) of claim 5, wherein:
the thermal-management operation (S101) further includes:
a management operation, including managing application of power to the grouping of thermal-management assemblies (142) of the molding system (140) in a way that minimizes energy consumption.

7. The system (100) of claim 5, wherein:
the thermal-management operation (S101) further includes:
a management operation, including managing application of power to the grouping of thermal-management assemblies (142) of the molding system (140) in a way that minimizes heat up time.

8. The system (100) of claim 5, wherein:
the determination operation (S102) further includes:
an application operation (S402), including: applying power to a thermal-management assembly (142) of the molding system (140);
a monitoring operation (S404), including: monitoring temperature response on a temperature sensor connected to the thermal-management assembly (142);
a power-off operation (S406) including: turning off power to the thermal-management assembly (142);
a watching operation (S408) including: monitoring temperature response on temperature sensor connected to the thermal-management assembly (142);
a creating operation (S410), including: creating a thermal-management influence vector for the thermal-management assembly (142) for temperature sensors associated with the thermal-management assembly (142);
a repeating operation (S412), including: repeating the application operation (S402), the monitoring operation (S404), the power-off operation (S406), the watching operation (S408), the creating operation (S410) for remaining thermal-management zones of the molding system (140); and
a generating operation (S414), including: generating a master-influence matrix for each thermal-management device on each thermal-management zone.

9. The system (100) of claim 5, wherein:
the determining operation (S104) further includes:
an input operation (S502), including: receiving user inputs for desired thermal set-points for the molding system (140);
a using operation (S504), including: using a master-influence matrix, and then determining a power-up sequence for each thermal-management zone, knowing how each thermal-management device's applied power affects the thermal-management zones of the molding system (140); and
an application operation (S506) including: applying power based on calculations performed, and bring the molding system (140) up to an operational temperature.

10. The system (100) of claim 5, wherein:
the identification operation (S106) further includes:
an inputting operation (S602), including: inputting user inputs identifying any one of a desired pause time and a desired restart time;
a using operation (S604), including: using a master-influence matrix so as to determines off time for each thermal management zone and turn the thermal-management devices back on to bring the molding system (140) back up to operating temperature; and
a waiting operation (S606), including: waiting for the molding system (140) to go back up to operating temperature after a prescribed pause duration.
